(19) United States
(12) Patent Application Publication
(10) Pub. No.: US 2012/0184210 A1
(43) Pub. Date: Jul. 19, 2012

(54) SYSTEM AND METHOD FOR DISPLAYING ELECTRIC QUANTITY OF BLUETOOTH EARPHONE ON PORTABLE ELECTRONIC EQUIPMENT

(75) Inventors: Yangmin WU, Huizhou (CN); Yike FENG, Huizhou (CN); Lian LIU, Huizhou (CN)

(73) Assignee: Huizhou TCL Mobile Communication Co., LTD., Huizhou City (CN)

(21) Appl. No.: 13/077,792

(22) Filed: Mar. 31, 2011

(30) Foreign Application Priority Data
Jan. 17, 2011 (CN) 2011100203784

(51) Int. Cl. H04B 7/00

(52) U.S. Cl. 455/41.2

(57) ABSTRACT

The present disclosure provides a system and a method for displaying an electric quantity of a bluetooth earphone on a portable electronic equipment. The system includes a bluetooth earphone and a portable electronic equipment. The bluetooth earphone includes a first communication module, a power management module, and a control module. The portable electronic equipment includes a second communication module, a processing module and a display module. The display module receives an electric quantity value from the processing module and displays it in form of an icon. The present disclosure can make a user observe a currently-used electric quantity of the bluetooth earphone when the bluetooth earphone is worn and cannot be observed.

### CROSS-REFERENCE TO RELATED APPLICATION

This application claims priority of Chinese Patent Application No. 201110020378.4, filed on Jan. 17, 2011, entitled “Systems and Methods for Displaying Electric Quantity of Bluetooth Earphone on Portable Electronic Equipment” by Yangmin Wu, Yike Feng, and Lian Liu, the disclosure of which is incorporated herein by reference in its entirety.

### TECHNICAL FIELD

The present disclosure generally relates to short distance wireless communication, and more particularly to systems and methods for displaying an electric quantity of a bluetooth earphone on a portable electronic equipment, and to a bluetooth earphone and a portable electronic equipment.

### BACKGROUND

Bluetooth is a short-distance wireless communication technique and is widely used in any personal mobile communication equipment.

A bluetooth technique has advantages of wide signal-receiving angle, energy saving, high transmission rate and so on. A bluetooth earphone, as the name implies, is an audio device that performs communication using a bluetooth transmission technique. A user can receive voice signals in a wireless transmission range (10 meters) of the bluetooth to, for example, pick up a telephone, listen to music, etc. When a conventional bluetooth earphone interconnects to a mobile terminal, the bluetooth earphone may intermittently cue the user using an LED (Light Emitting Diode) display lamp or using cue tone only if an electric quantity thereof is low. The user cannot view the electric quantity of the bluetooth earphone voluntarily.

Therefore, it is easy to cause a problem of break during a telephone communication, which brings out a significant inconvenience to the user.

### BRIEF SUMMARY OF THE PRESENT DISCLOSURE

An objective of the present disclosure is to provide a system for displaying an electric quantity of a bluetooth earphone on a portable electronic equipment. By the system, a user can examine the electric quantity to judge whether the bluetooth earphone should be charged. Accordingly, a problem that the electric quantity has been exhausted when intending to use the bluetooth earphone or that the power is broken suddenly during usage is addressed. A bluetooth earphone and a portable electronic equipment of above-mentioned system are also disclosed.

The present disclosure also provides a method for displaying an electric quantity of a bluetooth earphone on a portable electronic equipment.

The present disclosure has following technique effects. The power management module arranged in the bluetooth earphone may obtain the electric quantity parameter of the bluetooth earphone. The control module then controls the first communication module to transmit the electric quantity parameter to the second communication module of the portable electronic equipment, so that the electric quantity can be displayed on the portable electronic equipment. The user can examine the electric quantity to judge whether the bluetooth earphone should be charged. Accordingly, the above-mentioned problem is addressed.

The present disclosure can make the user observe a currently-used electric quantity of the bluetooth earphone when the bluetooth earphone is worn and cannot be observed.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is a schematic diagram of a system for displaying an electric quantity of a bluetooth earphone on a portable electronic equipment in accordance with the present disclosure;

FIG. 2 is flow chart of a method for displaying an electric quantity of a bluetooth earphone on a portable electronic equipment in accordance with the present disclosure;

FIG. 3 is a flow chart of a first embodiment of the systems and methods for displaying an electric quantity of a bluetooth earphone on the portable electronic equipment in accordance with the present disclosure;

FIG. 4 is a second embodiment of the systems and methods for displaying an electric quantity of a bluetooth earphone on the portable electronic equipment in accordance with the present disclosure;

FIG. 5 is a third embodiment of the systems and methods for displaying an electric quantity of a bluetooth earphone on the portable electronic equipment in accordance with the present disclosure; and

FIG. 6 is a diagrammatic drawing showing grade icons of electric quantity values of an embodiment of the systems and methods for displaying an electric quantity of a bluetooth earphone on the portable electronic equipment in accordance with the present disclosure.

### DETAILED DESCRIPTION OF EMBODIMENTS

Reference will now be made to the drawings to described exemplary embodiments in detail.

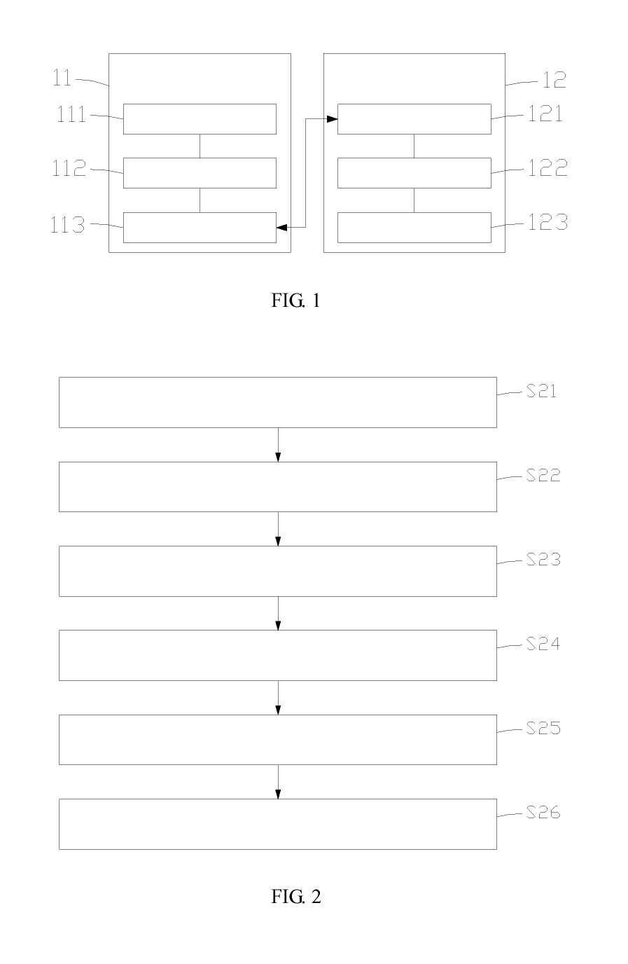

Referring to FIG. 1, a system for displaying an electric quantity of a bluetooth earphone on a portable electronic equipment in accordance with the present disclosure is provided. The system includes a bluetooth earphone 11 and a portable electronic equipment 12. The bluetooth earphone 11 includes a power management module 111, a control module 112 and a first communication module 113. The portable electronic equipment 12 includes a second communication module 121, a processing module 122 and a display module 123.

The power management module 111 computes a current electric quantity value of the bluetooth earphone 11, and converts the electric quantity value into an electric quantity parameter. The control module 112 receives data of the electric quantity parameter from the power management module 111, and transmits the data of the electric quantity parameter to the first communication module 113. The first communication module 113 transmits the data of the electric quantity parameter to the second communication module 121 via a bluetooth transmission protocol. The processing module 122 receives the data of the electric quantity parameter transmitted by the second communication module 121, and converts the electric quantity parameter into an electric quantity value. The display module 123 receives the electric quantity value from the processing module 122, and displays it in the form of an icon.

Specific working steps of the whole system are described as follows. An electric quantity enabling command and an electric quantity transmitting command are registered in the processing module 122 of the portable electronic equipment 12. The electric quantity enabling command is a command of the bluetooth earphone for requesting the portable electronic equipment to enable an electric-quantity display function. When the bluetooth earphone 11 and the portable electronic equipment 12 establish a wireless connection via the first communication module 113 and the second communication module 121, the power management module 111 computes a current electric quantity value of the bluetooth earphone 11 and converts it into an electric quantity parameter. The control module 112 controls the first communication module 113 to transmit the parameter to the second communication module 121 via the electric quantity transmitting command, and transmits the electric quantity enabling command to the second communication module 121 at the same time. The processing module 122 converts the electric quantity parameter received into an electric quantity value according to the electric quantity enabling command that has been registered and temporarily stored, and displays the electric quantity value of the bluetooth earphone 11 via the display module 123.

Referring to FIG. 2, a flow chart of a method for displaying an electric quantity of a bluetooth earphone on a portable electronic equipment is shown. The method for displaying the electric quantity has steps as follows. S21, preliminarily registering an electric quantity enabling command and an electric quantity transmitting command in the processing module. S22, the power management module computes a current electric quantity value of the bluetooth earphone, and transmits the electric quantity value to the control module in the form of electric quantity parameter via the electric quantity transmitting command. S23, the control module controls the first communication module to transmit the electric quantity enabling command and the electric quantity transmitting command to the second communication module. S24, the second communication module receives the electric quantity enabling command and the electric quantity transmitting command and transmits them to the processing module via a bluetooth transmission protocol. S25, the processing module analyzes the two commands according to previous information that is preliminarily registered, and converts the electric quantity parameter received into a corresponding electric quantity value and transmits it to the display module. S26, the display module receives the electric quantity value, and displays a corresponding electric quantity value in form of an icon.

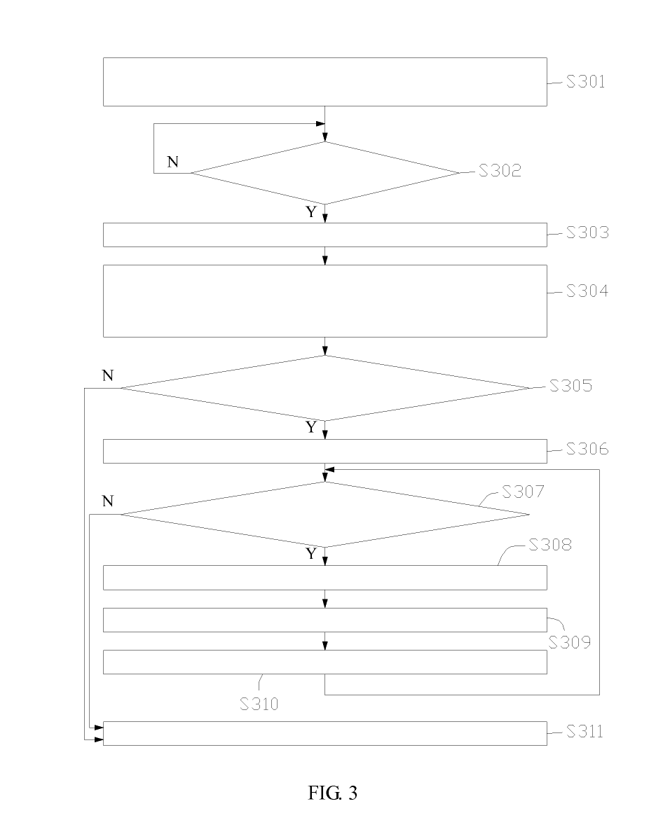

Referring to FIG. 3, a flow chart of a first embodiment in accordance with the present disclosure is shown. The flow chart begins with S301: enabling a bluetooth function of a portable electronic equipment (which may be a mobile communication terminal, a notebook computer, a PDA (Personal Digital Assistant), etc.), and searching for a bluetooth earphone. S302, the electronic equipment searches for the bluetooth earphone, and enquires whether a matching code should be inputted so as to establish a connection. S303, the electronic equipment and the bluetooth earphone are connected by inputting the matching code, and the bluetooth earphone may transmit an electric quantity enabling command to the electronic equipment. S304, the bluetooth earphone enables a function for displaying an electric quantity, and a power management module in the bluetooth earphone computes a current electric quantity value of the bluetooth earphone and converts it into an electric quantity parameter, and transmits the electric quantity parameter at the same time via an electric quantity transmitting command. S305, whether the electronic equipment receives the electric quantity enabling command transmitted by the bluetooth earphone again? If yes, turning to S306. If not, turning to S311. S306, the electronic equipment receives the electric quantity enabling command, and returns a confirmation to the bluetooth earphone. S307, whether the electronic equipment receives an electric quantity transmitting command containing the electric quantity parameter? If yes, turning to S308. If not, turning to S311. S308, the electronic equipment receives the electric quantity transmitting command, and returns a confirmation to the bluetooth earphone. S309, converting the electric quantity parameter into an electric quantity value. S310, the electronic equipment displays the electric quantity value of the bluetooth earphone. Actions from S310 to S306 may continuously cycle to and fro. S311, displaying an icon representing an ordinary connection status between the bluetooth earphone and the electronic equipment.

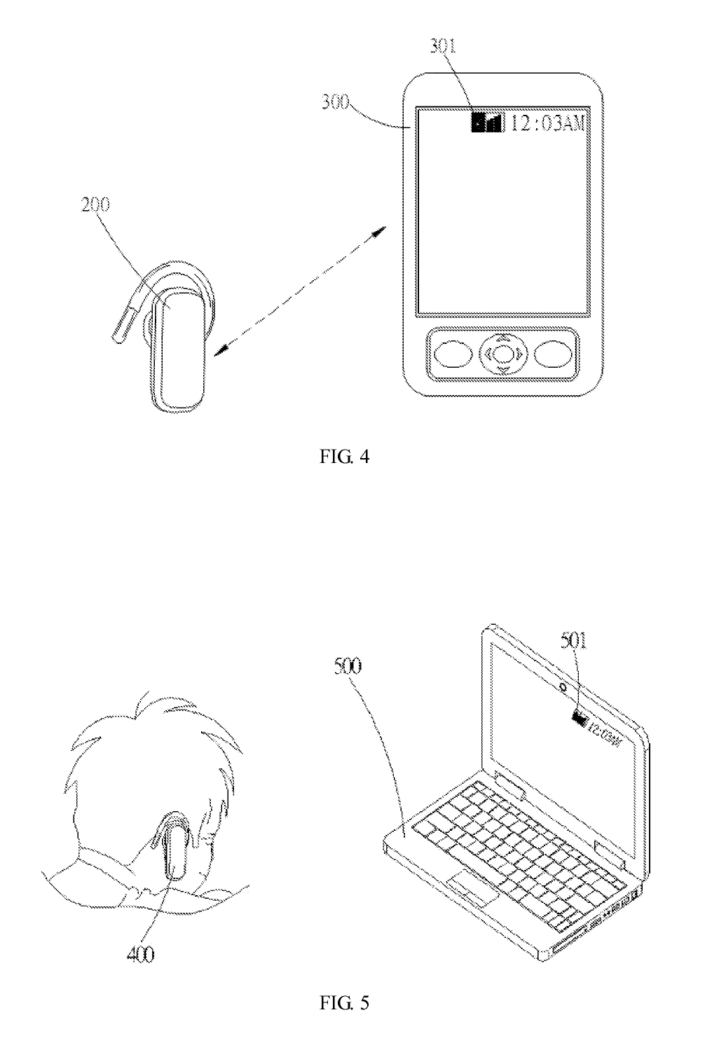

Referring to FIG. 4, a second embodiment in accordance with the present disclosure is shown. In this figure, a user establishes a wireless communication connection between a bluetooth earphone 200 and a mobile communication terminal 300 via a bluetooth technique. When the user establishes the connection via the bluetooth earphone 200, the bluetooth earphone 200 may transmit an electric quantity enabling command and an electric quantity transmitting command to the mobile communication terminal 300. The mobile communication terminal 300 may register the two commands and temporarily store them. Then, a power management module in the bluetooth earphone 200 may compute a current electric quantity value of the bluetooth earphone 200 and convert it into an electric quantity parameter. The bluetooth earphone 200 may transmit the electric quantity parameter to the mobile communication terminal 300 according to an electric quantity enabling command and an electric quantity transmitting command. The mobile communication terminal 300 may perform a comparison according to the electric quantity enabling command and the electric quantity transmitting command which have been registered and temporarily stored, and convert the electric quantity parameter received into an electric quantity value. Then, the electric quantity of the bluetooth earphone is displayed on the mobile communication terminal in form of an icon. In the present disclosure, the mobile communication terminal may be an android mobile communication terminal.

Referring to FIG. 5, a third embodiment of the systems and methods for displaying an electric quantity of a bluetooth earphone on a portable electronic equipment in accordance with the present disclosure is shown. In this figure, a user establishes a wireless communication connection between a bluetooth earphone 400 and a notebook computer 500 via a bluetooth technique. The bluetooth earphone 400 may transmit an electric quantity enabling command and an electric quantity transmitting command to the notebook computer 500, and the notebook computer 500 may register the two commands and temporarily store them. When the user communicates utilizing the bluetooth earphone 400, a power management module in the bluetooth earphone 400 may continuously compute an electric quantity value of the bluetooth earphone 400 and convert it into an electric quantity parameter. Then, the bluetooth earphone 400 may transmit the electric quantity parameter to the notebook computer 500 according to the electric quantity enabling command and the electric quantity transmitting command. The notebook computer 500 may convert the electric quantity parameter into an electric quantity value according to the two commands which have been registered and temporarily stored, and display an electric quantity value icon 501 on its screen. Thus, the electric quantity value of the bluetooth earphone 400 is displayed.

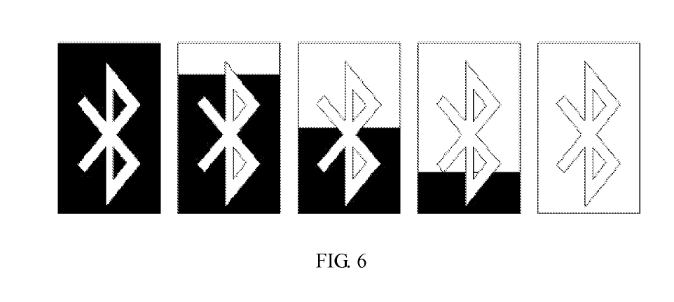

In the third embodiment, a maximum number of the electric quantity value of the bluetooth earphone 400 is 100. The electric quantity value may be divided into five grades. A first grade is 100-80, a second grade is 80-60, a third grade is 60-40, a fourth grade is 40-10, and a fifth grade is 10-0. Icons 501 for corresponding electric quantity values of the five grades are shown in FIG. 6. In this figure, the first grade, the second grade, the third grade, the fourth grade and the fifth grade are illustrated from left to right. When the electric quantity value of the bluetooth earphone 400 changes from a grade to another grade, the bluetooth earphone 400 transmits an electric quantity parameter corresponding to a current electric quantity value grade to the notebook computer 500 according to the electric quantity transmitting command. The notebook computer 500 may display an electric quantity value icon 501 corresponding to the electric quantity value grade of the bluetooth earphone 400 on its screen. Of course, the electric quantity value may be divided into four or six grades as desired.

Referring to FIG. 6, an electric quantity value of a bluetooth earphone is displayed on a portable electronic equipment via five icons in accordance with the present disclosure. Of course, the electric quantity value may be divided into four or six grades as desired. A chip in the bluetooth earphone may define a full earphone electric quantity as 100 while the minimum unit is 1, and defines an exhausted electric quantity as 0. The electric quantity value is hereby divided into five grades. The first grade is 100-80, the second grade is 80-60, the third grade is 60-40, the fourth grade is 40-10, and the fifth grade is 10-0. When the electric quantity decreases one unit, the power management module 111 may recompute the electric quantity value of the bluetooth earphone 11 immediately and convert it into an electric quantity parameter. The electric quantity parameter is transmitted to the second communication module 121 via the first communication module 113. The second communication module 121 transmits the electric quantity parameter received to the processing module 122. The processing module 122 converts the parameter into a corresponding electric quantity value, and transmits it to the display module 123. The display module analyzes a current electric quantity value and displays an icon for the current electric quantity. When the electric quantity of the bluetooth earphone 11 changes from a grade to another grade, the display module may analyze according to the current electric quantity value and display a new icon for the electric quantity.

In summary, by utilizing the systems and methods for displaying an electric quantity of a bluetooth earphone on a portable electronic equipment in accordance with the present disclosure, a currently-used electric quantity of the bluetooth earphone can be displayed momentarily. The user can examine the electric quantity to judge whether the bluetooth earphone should be charged. Accordingly, a problem that the electric quantity has been exhausted when intending to use the bluetooth earphone or that the power is broken suddenly during usage is addressed.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broad general meaning of the terms in which the appended claims are expressed.

What is claimed is:

1. A system for displaying an electric quantity of a bluetooth earphone on a portable electronic equipment, comprising:
a bluetooth earphone comprising:
a first communication module;
a power management module for computing a current electric quantity value of the bluetooth earphone and converting the electric quantity value into an electric quantity parameter; and
a control module for receiving data of the electric quantity parameter from the power management module and transmitting the data of the electric quantity parameter to the first communication module; and
a portable electronic equipment comprising:
a second communication module;
a processing module; and
a display module;
wherein the second communication module receives the data of the electric quantity parameter transmitted by the first communication module via a bluetooth transmission protocol, the processing module receives the data of the electric quantity parameter transmitted by the second communication module and converts the electric quantity parameter into an electric quantity value, and the display module receives the electric quantity value from the processing module and displays it in form of an icon.

2. The system for displaying an electric quantity of a bluetooth earphone on a portable electronic equipment according to claim 1, wherein the control module controls the first communication module to transmit an electric quantity enabling command and an electric quantity transmitting command containing the electric quantity parameter to the second communication module.

3. The system for displaying an electric quantity of a bluetooth earphone on a portable electronic equipment according to claim 2, wherein the electric quantity enabling command is a command of the bluetooth earphone for requesting the portable electronic equipment to enable an electric-quantity display function.

4. The system for displaying an electric quantity of a bluetooth earphone on a portable electronic equipment according to claim 1, wherein the portable electronic equipment is a mobile communication terminal, a notebook computer, or a personal digital assistant.

5. The system for displaying an electric quantity of a bluetooth earphone on a portable electronic equipment according to claim 1, wherein the electric quantity value is divided into a plurality of grades, and wherein when the electric quantity value of the bluetooth earphone changes from a grade to another grade, the display module performs analysis and displays a new icon for the electric quantity value.

6. A method for displaying an electric quantity of a bluetooth earphone on a portable electronic equipment, the bluetooth earphone comprising a first communication module, a power management module and a control module, the portable electronic equipment comprising a second communication module, a processing module and a display module, wherein the method for displaying the electric quantity comprises the following steps:
the power management module computing a current electric quantity value of the bluetooth earphone and converting the electric quantity value into an electric quantity parameter;
the control module controlling the first communication module to transmit the electric quantity parameter;
the second communication module receiving the electric quantity parameter via a bluetooth transmission protocol;
the processing module converting the electric quantity parameter into an electric quantity value; and
the display module displaying the electric quantity value.

7. The method for displaying an electric quantity of a bluetooth earphone on a portable electronic equipment according to claim 6, wherein the control module controls the first communication module to transmit an electric quantity enabling command and an electric quantity transmitting command containing the electric quantity parameter to the second communication module.

8. The method for displaying an electric quantity of a bluetooth earphone on a portable electronic equipment according to claim 7, wherein the electric quantity enabling command is a command of the bluetooth earphone for requesting the portable electronic equipment to enable an electric-quantity display function.

9. The method for displaying an electric quantity of a bluetooth earphone on a portable electronic equipment according to claim 6, wherein the display module displays the electric quantity value in form of an image.

10. The method for displaying an electric quantity of a bluetooth earphone on a portable electronic equipment according to claim 6, wherein the electric quantity value is divided into a plurality of grades, and wherein when the electric quantity value of the bluetooth earphone changes from a grade to another grade, the display module performs analysis and displays a new icon for the electric quantity.

11. The method for displaying an electric quantity of a bluetooth earphone on a portable electronic equipment according to claim 6, wherein the portable electronic equipment is a mobile communication terminal, a notebook computer, or a personal digital assistant.

12. A bluetooth earphone, comprising:
a first communication module;
a power management module for computing a current electric quantity value of the bluetooth earphone and converting the electric quantity value into an electric quantity parameter; and
a control module for receiving data of the electric quantity parameter from the power management module and transmitting the data of the electric quantity parameter to the first communication module;
wherein the first communication module is configured for transmitting the data of the electric quantity parameter to a second communication module arranged in a portable electronic equipment.

13. The bluetooth earphone according to claim 12, wherein the portable electronic equipment is a mobile communication terminal, a notebook computer, or a personal digital assistant.

14. A portable electronic equipment, comprising:
a second communication module;
a processing module; and
a display module;
wherein the second communication module is configured for receiving data of an electric quantity parameter transmitted by a first communication module via a bluetooth transmission protocol, the processing module receives the data of the electric quantity parameter transmitted by the second communication module and converts the electric quantity parameter into an electric quantity value, and the display module receives the electric quantity value from the processing module and displays it in form of an icon; and
wherein the first communication module is arranged in a bluetooth earphone.

15. The portable electronic equipment according to claim 14, wherein the portable electronic equipment is a mobile communication terminal, a notebook computer, or a personal digital assistant.
